(19) United States
(12) Patent Application Publication
(10) Pub. No.: US 2021/0404629 A1
(43) Pub. Date: Dec. 30, 2021

(54) OPTICAL FILM, BACKLIGHT MODULE HAVING OPTICAL FILM AND DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Pengfei Cheng, Beijing (CN); Haiwei Sun, Beijing (CN); Jian Sang, Beijing (CN); Zhiyong Chen, Beijing (CN); Junjie Ma, Beijing (CN); Lu Yu, Beijing (CN)

(21) Appl. No.: 16/474,743

(22) PCT Filed: Nov. 26, 2018
(86) PCT No.: PCT/CN2018/117420

§ 371 Date: Jun. 28, 2019

(30) Foreign Application Priority Data
Apr. 25, 2018 (CN) 201810378344.4

(51) Int. Cl. F21V 9/14; F21V 9/30

(52) U.S. Cl. CPC F21V 9/14; F21Y 2115/10; F21V 9/30

(57) ABSTRACT

An optical film, a backlight module having an optical film and a display device are provided according to the present disclosure. The optical film includes: a polarizing film configured to convert incident light into polarized light and transmit the polarized light; and a diffusion film arranged on the polarizing film and including scattering particles capable of forming Rayleigh scattering. The backlight module includes the optical film and a light source, where the light source is arranged at a side of the polarizing film far away from the diffusion film.

### CROSS-REFERENCE TO RELATED APPLICATION

This application is the U.S. national phase of PCT Application No. PCT/CN2018/117420 filed on Nov. 26, 2018, which claims a priority to Chinese Patent Application No. 201810378344.4 filed on Apr. 25, 2018, the disclosures of which are incorporated in their entirety by reference herein.

### TECHNICAL FIELD

The present disclosure relates to the field of display technology, in particular to an optical film, a backlight module having an optical film and a display device.

### BACKGROUND

Due to considerations into cost and power consumption, the number of light emitting diodes (LED) in a direct-type backlight is limited, and the LEDs are spaced from each other by a certain interval, which leads to generation of LED shadows at a certain position from the LEDs. Hence, a light uniformizing technology is required to eliminate the LED shadows. In general, light uniformizing is performed with a diffusion film or a diffusion plate, while the diffusion plate is too thick to allow a direct-type backlight product to get thinner. The diffusion film in related art is generally based on the principle of Mie scattering or geometric optics to achieve diffusion of light, which has various disadvantages such as an incapability of thinning a product, poor light uniformizing effects and loss of brightness. For example, diffusion performance is limited in a direct-type backlight with a large interval between LEDs, and a brightness will be reduced if a haze of the diffusion film is increased to improve the diffusion performance.

### SUMMARY

In a first aspect, an optical film is provided according to the embodiments of the present disclosure, which includes:

a polarizing film, configured to convert incident light into polarized light and transmit the polarized light; and

a diffusion film, arranged on the polarizing film and including a scattering particle capable of forming Rayleigh scattering.

In some optional embodiments, a diameter d of the scattering particle and a wavelength γ of light incident on the diffusion film meet the following equation: d=αλ/π.

where in a case that α<0.3, Rayleigh scattering occurs when incident light with the wavelength of λ encounters the scattering particle, and α is a dimensionless particle size parameter.

In some optional embodiments, the polarizing film is a dual brightness enhance film, and is configured to divide the incident light into P-polarized light and S-polarized light with mutually perpendicular polarization directions, transmit the P-polarized light and reflect the S-polarized light.

In some optional embodiments, the diameter of the scattering particle is smaller than 70 nm.

In a second aspect, a backlight module is provided according to the embodiments of the present disclosure, which includes:

the optical film according to the embodiments in the first aspect of the present disclosure; and

a light source, arranged at a side of the polarizing film far away from the diffusion film.

In some optional embodiments, the backlight module further includes:

a quantum dot film, arranged at a side of the diffusion film far away from the polarizing film, where quantum dots in the quantum dot film emit a second light ray under excitation of a first light ray emitted by the light source, and a wavelength of the second light ray is smaller than a wavelength of the first light ray.

In some optional embodiments, the backlight module further includes:

a reflective film, arranged at a side of the light source far away from the polarizing film.

In some optional embodiments, the light source includes a blue LED chip.

In some optional embodiments, the light source includes multiple blue LED chips that are equally spaced.

In some optional embodiments, in a case that the light source emits blue light, the quantum dots in the quantum dot film emit green-waveband light and red-waveband light under excitation of the blue light.

In some optional embodiments, the reflective film is an enhanced specular reflector (ESR) film.

In a third aspect, a display device is provided according the embodiments of the present disclosure, which includes:

a display panel; and

the backlight module according to the embodiments in the second aspect of the present disclosure,

where the display panel is arranged at a light-emitting surface of the backlight module.

### BRIEF DESCRIPTION OF THE DRAWINGS

FIG. 1 is a schematic structural diagram of an optical film according to at least one embodiment of the present disclosure;

FIG. 2 is a schematic diagram showing a scattering effect of Mie scattering;

FIG. 3 is a schematic diagram showing a scattering effect of Rayleigh scattering;

FIG. 4 shows an angular distribution of Rayleigh scattering intensity in a case that incident light is natural light;

FIG. 5 shows an angular distribution of Rayleigh scattering intensity in a case that incident light is polarized light;

FIG. 6 is a schematic structural diagram of a backlight module according to at least one embodiment of the present disclosure; and

FIG. 7 is a schematic diagram of a backlight module in cooperation with a display panel according to at least one embodiment of the present disclosure.

### DETAILED DESCRIPTION

In order to better clarify the technical problem to be solved by the present disclosure, the technical solutions and advantages of the present disclosure, the technical solutions according to the embodiments of the present disclosure are described clearly and completely hereinafter in conjunction with the appended drawings of the embodiments. Apparently, the embodiments described are only some rather than all embodiments of the present disclosure. Any other embodiments obtained by those skilled in the art based on the embodiments of the present disclosure shall fall within the scope of the present disclosure.

An optical film, a backlight module having an optical film and a display device are provided according to embodiments of the present disclosure, to address the issues of incapability of thinning, poor light uniformizing effects and loss of brightness in a conventional diffusion film.

An optical film according to embodiments of the present disclosure is first described hereinafter.

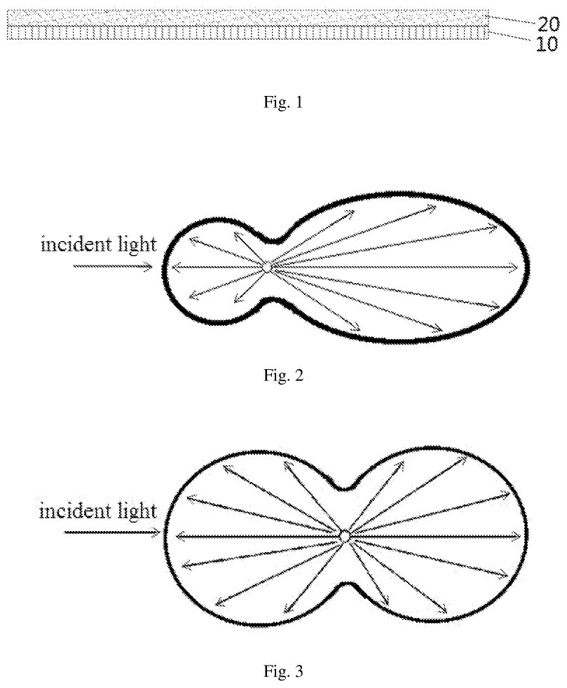

As shown in FIG. 1, the optical film according to the embodiments of the present disclosure includes a polarizing film 10 and a diffusion film 20 that are stacked.

The polarizing film 10 is configured to convert incident light into polarized light to exit, and the diffusion film 20 is arranged at a light-exiting surface of the polarizing film 10 and includes scattering particles capable of forming Rayleigh scattering.

That is, the optical film is mainly formed by the polarizing film 10 and the diffusion film 20. The polarizing film 10 may be configured to convert incident light into polarized light to exit, and the diffusion film 20 is arranged at a light-exiting surface of the polarizing film 10. The polarized light exiting from the polarizing film 10 is incident on the diffusion film 20, and as diffusion film 20 includes diffusion particles, Rayleigh scattering can be formed when the light collides with the scattering particle, so that the polarized light incident on the diffusion film 20 can be more uniform through the Rayleigh scattering, thereby improving light uniformizing performance and brightness of light.

As shown in FIGS. 2 and 3, where FIG. 2 is a schematic diagram showing a scattering effect of Mie scattering and FIG. 3 is a schematic diagram showing a scattering effect of Rayleigh scattering. As shown in FIG. 2, in a case that incident light enters a scattering particle with a large diameter, the scattering particle performs Mie scattering on the incident light, and rays of scattered light generated from the Mie scattering are centralized in a forward direction of the scattering particle and decentralized in a backward direction of the scattering direction, where thus rays of the scattered light are not uniformly distributed in the forward and backward directions of the scattering particle. As shown in FIG. 3, in a case that incident light enters a scattering particle with a small diameter, the scattering particle performs Rayleigh scattering on the incident light, and rays of scattered light generated from the Rayleigh scattering is uniformly distributed in forward and backward directions of the scattering particle. Hence, Rayleigh scattering is more uniform than Mie scattering, and light uniformization can be achieved in a small light blending distance by applying Rayleigh scattering to diffusion of backlight for light uniformization, where conventional Mie scattering is replaced with Rayleigh scattering involving scattering particles with a smaller diameter and light generated from the Rayleigh scattering is more uniform, thereby facilitating simplifying of structure of a backlight module.

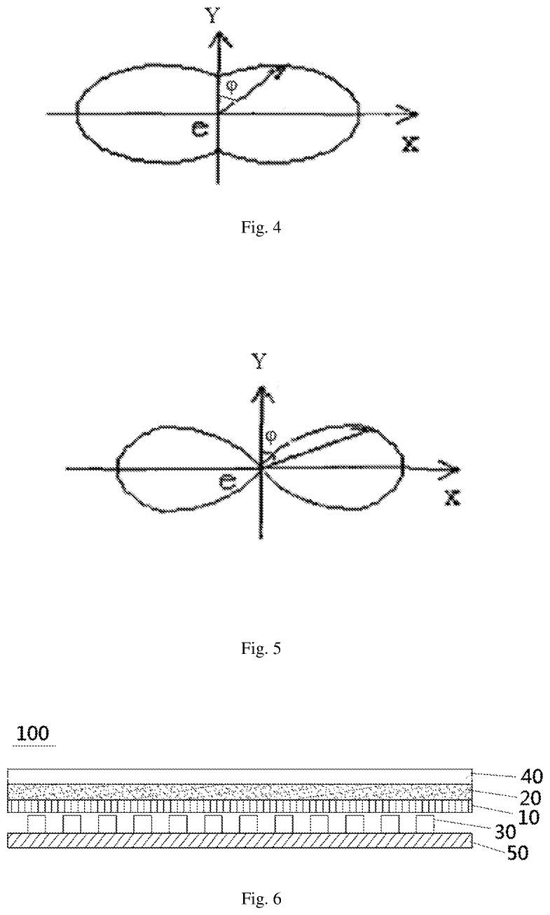

Light emitted by a conventional backlight is natural light, and may lose 50% of its brightness after passing through a polarizer. Polarized light can be emergent from the optical film according to the present disclosure, and thus no polarizer is required additionally, which can reduce the loss of brightness. Reference is made to FIGS. 4 and 5, where FIG. 4 shows an angular distribution of Rayleigh scattering intensity in a case that incident light is natural light, and FIG. 5 shows an angular distribution of Rayleigh scattering intensity in a case that incident light is polarized light. In the Figures, e represents an electric field of the incident light, horizontal coordinate axis X represents a direction parallel with an electric field vector, vertical coordinate axis Y represents a direction perpendicular to the electric field vector, φ represents an angle corresponding to an intensity of scattered light, and the curve is an angular distribution curve of Rayleigh scattering light. It can be seen from FIGS. 4 and 5, an angular distribution of Rayleigh scattering intensity of polarized light better conforms to the formula of scattering intensity distribution of Rayleigh scattering, and polarized light has stronger Rayleigh scattering effects than natural light. Thus, effects of Rayleigh scattering can be enhanced by generating polarized light with the polarizing film 10. Light passing through the polarizing film 10 is polarized light, and a Rayleigh scattering property of polarized light lies in that a polarization property of the polarized light is not changed by the Rayleigh scattering, where the polarized light remains polarized light. By applying the optical film to a backlight module, an overall brightness of the module can be improved and a thickness of the module can be reduced.

In view of the above, the optical film according to the embodiments of the present disclosure solves the technical problem that a diffusion film in related art cannot be thinned, has a poor light uniformization performance and introduces loss of brightness. The polarizing film 10 may convert incident light into polarized light and transmit the polarized light, so that light exiting from the diffusion film 20 is polarized light, where polarized light has better diffusion and uniformization performance. The scattering particles in the diffusion film 20 may perform Rayleigh scattering on the polarized light exiting from the polarizing film 10, thereby improving light uniformization performance, improving a brightness after diffusion and reducing a thickness of the optical film. Light uniformization is achieved and a light blending distance is reduced by Rayleigh scattering.

In some embodiments of the present disclosure, a diameter of the scattering particle and a wavelength of light incident on the diffusion film 20 are related by the following equation:

d=αλ/π,

where Rayleigh scattering occurs when incident light collides with the scattering particle in a case that α<0.3,

where α is a dimensionless particle size parameter, d is the diameter of the scattering particle, and λ is a wavelength of the light incident on the diffusion film 20.

That is to say, in Rayleigh scattering, the diameter d of the scattering particle is related to the wavelength λ of the light incident on the diffusion film 20, where the wavelength λ of the light incident on the diffusion film 20 is determined once incident light is determined. In a case that the light incident on the diffusion film 20 is monochromatic light, for example, blue light, the calculation is performed on basis of a wavelength of the blue light. The light may also be polychromatic light, for example white light. If some monochromatic light with the longest wavelength in the polychromatic light meets the condition of Rayleigh scattering, other monochromatic light with shorter wavelengths in the polychromatic light can also achieve Rayleigh scattering; therefore, λ is preferably a wavelength of blue light. The diameter of the scattering particle can be calculated by the foregoing equation, for example, in a case that the wavelength of the incident light is 500 nm, it can be calculated by the equation that Rayleigh scattering can be achieved under the condition that the diameter of the scattering particle is smaller than 47.77 nm. The scattering intensity of the scattering particle to the incident light can be calculated by the Rayleigh scattering formula, and the scattering intensity distribution of the Rayleigh scattering is given by the following formula:

$$I = {I}_{0} \frac{{π}^{4} {d}^{6}}{4 {r}^{2} {λ}^{4}} ( \frac{{m}^{2} - 1}{{m}^{2} + 1} ) sin ϕ ,$$

where I is the scattering intensity, I₀ is an intensity of the incident light, r is a distance between the scattering particle and a receiving point or an observation point, φ is an angle corresponding to an intensity of scattered light, and m is a relative refractive index of the scattering particle.

According to the formula of scattering intensity distribution, the scattering intensity of the Rayleigh scattering is inversely proportional to a biquadrate of the wavelength of the incident light, where the shorter the wavelength of the incident light is, the higher the scattering intensity of the Rayleigh scattering is. For example, in a case that blue light with a short wavelength is used, the scattering intensity of the blue light is higher than light with a longer wavelength, facilitating improving an overall brightness of a direct-type backlight module. The angular distribution of the scattering intensity depends on φ, where the scattering intensity is the minimum, which is zero, in an electric field vector direction of the incident light or in a dipole direction of the scattering particle, and reaches the maximum in a direction perpendicular to the electric field vector direction.

In some optional embodiments, the diameter of the scattering particle is smaller than 70 nm. In a case that the incident light is red light of which a wavelength is around 700 nm, the Rayleigh scattering occurs when the red light is incident on the scattering particle with a diameter smaller than 70 nm.

Scattering particles in a typical diffusion film of a backlight module in related art has a diameter in a range of 0.1 μm to 10 μm, which is in condition for Mie scattering. In a case that α>1, a diameter of a corresponding scattering particle is about in a range of 0.1 μm to 10 μm, which is subject to description under Mie scattering theory, and a scattering intensity thereof is accordingly subject to solution under Mie scattering theory. In a case that diameter of the scattering particle meets α<0.3, the diameter of the corresponding scattering particle is smaller than 0.05 μm, which is subject to description under Rayleigh scattering theory, and a scattering intensity thereof is subject to solution under Rayleigh scattering theory. In a case that α>>1, the diameter of the scattering particle is large, and scattering of the scattering particle fall within the scope of geometric optics and does not conform to Rayleigh scattering theory or Mie scattering theory. Thus, compared with Mie scattering, a scattering particle for generating Rayleigh scattering has a smaller diameter, and given a same wavelength, the smaller the diameter of the scattering particle is, the more easily Rayleigh scattering occurs. Under the circumstance that Rayleigh scattering is achieved, the shorter the wavelength is, the higher the Rayleigh scattering intensity is. In practical application, light with an appropriate wavelength and a scattering particle with an appropriate diameter are to be selected in accordance with practical needs, to achieve desirable performance of Rayleigh scattering.

In some embodiments of the present disclosure, the polarizing film 10 may be a dual brightness enhance film. The dual brightness enhance film is formed by alternately stacking anisotropic high-refractivity materials and low-refractivity materials to form multiple layers, where the number of the layers is about 1000, generates polarized light based on the birefringent effect and forms a reflection enhancement condition for polarized light in one direction with the multi-layer film structure so that finally, only the polarized light in the direction is reflected. According to the Fresnel equation, in an interface between two media, a medium thickness meeting a transmittance enhancement or reflection enhancement condition is generally ¼ of an incident light wavelength. For example, in a case that light with a wavelength of 500 nm is incident from air onto a surface of a medium with a refractive index of 1.5, in order to meet the transmittance enhancement or reflection enhancement condition, a corresponding medium thickness is about 500 nm/4/1.5=83.3 nm, and accordingly, a thickness of the 1000-layer film to meet the thickness requirement is about 83 μm.

The dual brightness enhance film divides incident non-polarized light into two linear polarized light rays with mutually perpendicular polarization directions, P-polarized light and S-polarized light, where all the P-polarized light passes through the dual brightness enhance film and the S-polarized light is reflected. Polarized light is a kind of light of which a vibration direction of an optical vector does not change or change regularly, P-polarized light is linearly polarized light of which a polarization direction is parallel with an incident surface, and S-polarized light is linearly polarized light of which a polarization direction is normal to the incident surface. Any kind of polarized light can be seen as a vector sum of S-polarized light and P-polarized light. The polarizing film 10 can transmit P-polarized light parallel with the incident surface, and reflect S-polarized light normal to the incident surface. The reflected S-polarized light can be blended with other light to form natural light, and the natural light is then incident on the polarizing film 10, improving utilization of light.

A backlight module 100 is further provided according to an embodiment of the present disclosure. As shown in FIG. 6, the backlight module 100 includes the optical film according to the above embodiments of the present disclosure and a light source. The light source may be arranged at a side of the polarizing film 10 far away from the diffusion film 20, and at a distance from the polarizing film 10, which may be spaced from each other by an appropriate distance. There may be multiple light sources, which may be equally spaced from each other so as to emit uniform light onto the polarizing film 10. Non-polarized light emitted by the light source enters the polarizing film 10 and is converted into polarized light, and the polarized light is transmitted out. The polarized light is subjected to Rayleigh scattering by the scattering particles in the diffusion film 20, and the scattered light is uniformly distributed in different directions, which can enhance the light uniformization performance, improve the brightness of the backlight module and facilitating thinning of the backlight module.

In some embodiments of the present disclosure, the light source may include a blue LED chip 30, and the scattering intensity and light uniformization performance can be improved by emitting blue light onto the polarizing film 10 with the blue LED chip, as blue light has a short wavelength. The light source may include multiple blue LED chips 30, which may be equally spaced or arranged in an array, and an interval therebetween may be selected properly on practical demands, so that the blue LED chips 30 can emit uniform blue light onto the polarizing film 10, thereby improving the brightness of the backlight module.

In some embodiments of the present disclosure, the backlight module 100 may further include a quantum dot film 40, and the quantum dot film 40 may be arranged at a side of the diffusion film 20 far away from the polarizing film 10 and can convert blue light into white light. The blue LED chip 30 emits blue light onto the polarizing film 10, and the polarized light exiting from the polarizing film 10 becomes more uniform after being diffused by the diffusion film 20. Blue light exiting from the diffusion film 20 may be incident on the quantum dot film 40, quantum dots in the quantum dot film 40 can emit green-waveband light and red-waveband light under excitation of the blue light, and the red light, the green light and the blue light can be blended to form white light.

The quantum dot material in the quantum dot film 40 is like fluorescent powder, which is also a photoluminescent material. Quantum dot is a nanoscale semiconductor, which emits light with a specific frequency when a specific electric filed or radiation pressure is applied thereto. The frequency of the emitted light varies with dimensions of the nanoscale semiconductor, and accordingly, a color of the emitted light can be controlled by altering the dimensions of the nanoscale semiconductor. In general, light with a long wavelength can be generated by Stokes shift under excitation of a short wavelength laser. For example, the nanoscale semiconductor emits green-waveband light and red-waveband light under excitation of blue light with a wavelength of 450 nm, and white light is generated by blending the red, green and blue lights.

In some embodiments of the present disclosure, the polarizing film 10 may be a dual brightness enhance film, which divides incident non-polarized light into two linear polarized light rays with mutually perpendicular polarization directions, P-polarized light and S-polarized light, where all the P-polarized light passes through the dual brightness enhance film and the S-polarized light is reflected. The backlight module 100 may further include a reflective film 50, where the reflective film 50 may be arranged at a side of the blue LED chip 30 far away from the polarizing film 10. The blue LED chip 30 may be arranged on the reflective film 50 and between the reflective film 50 and the polarizing film 10. With this structure, blue light emitted by the blue LED chip 30 enters the polarizing film 10 and is divided into P-polarized light and S-polarized light. All the P-polarized light is incident on the diffusion film 20 after passing through the polarizing film 10, and undergoes Rayleigh scattering, where scattered light is uniformly distributed in different directions. The S-polarized light is reflected by the polarizing film 10 into the reflective film 50, and turns into blended light rays of P-polarized light and S-polarized light after being reflected by the reflective film 50, where the blended light rays enter the polarizing film 10 thereafter. Continuing in this manner, the S-polarized light can be reflected between the polarizing film 10 and the reflective film 50 for multiple times. In this way, more light rays are converted into P-polarized light by the polarizing film 10 and are then incident on the diffusion film 20, thereby improving utilization of the light source.

The reflective film 50 may be varied, and silver is a material used to form the reflective film, where the reflective film is fabricated by coating a silver layer on a base material and has a high reflectivity for light. The reflective film 50 may be an enhanced specular reflector (ESR) film. The ESR film is highly reflective and may be made of plastic. The ESR film is similar to a reflective polarizer in respect of structure, which also achieves a high reflectivity by a structure with multiple high-refractivity and low-refractivity film layers, and bears an advantage of high reflectivity for light in all wavebands, where a reflectivity for light with a wavelength between 380 nm and 760 nm can reach 98%. The reflective polarizer is made of multiple layers of anisotropic material, and the ESR film is different from the reflective polarizer in that the ESR film is made of multiple layers of isotropic material having a same refractive index in different directions and does not generate polarized light but highly reflects incident light.

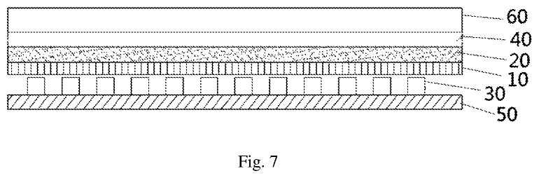

The ESR film may be a film highly reflective for blue light, and the wavelength range with high reflectivity may be 380 nm to 490 nm, so that S-polarized light reflected by the polarizing film 10 can be effectively reflected by the ESR film. The S-polarized light, after being reflected by the ESR film, turns into natural light of blended P-polarized light and S-polarized light, the natural light is directed to the polarizing film 10, where the P-polarized light is transmitted and the S-polarized light is reflected back to the ESR film. The above process is performed periodically, so that the P-polarized light exits from the polarizing film 10 and scattered light generated through Rayleigh scattering performed on the P-polarized light by the scattering particle in the diffusion film 20 is uniformly distributed in different directions. The polarizing film 10 may also be designed to be highly reflective for blue light, improving the intensity of blue light reflected back to the ESR film, and can improve a brightness and light uniformization performance of the whole module in conjunction with the ESR film highly reflective for blue light. As shown in FIG. 7, display performance of a display panel 60 can be improved by combining the backlight module according to the present disclosure with the display panel 60 in application.

In the backlight module 100 according to the embodiments of the present disclosure, blue light emitted by the blue LED chip 30 enters the polarizing film 10 and is diffused by the diffusion film 20, which enhances the light uniformization performance, improves the overall brightness of the backlight module 100 and facilitates thinning of a product; and the quantum dots in the quantum dot film 40 emit green-waveband light and red-waveband light under excitation of the blue light, the red light, green light and blue light are blended to form natural light, and the reflective film 50 can reflect S-polarized light, which improves light utilization efficiency and the brightness of the module.

The display device according to the embodiments of the present disclosure includes the backlight module according to the embodiments above of the present disclosure. As the backlight module according to the embodiments above has the foregoing technical effects, the display device according to the embodiments of the present disclosure also has the same technical effects, where the backlight module has a high brightness and desirable light uniformization performance and facilitates thinning of the display device.

In addition to the backlight module, the display device according to the embodiments of the present disclosure further includes the display panel 60, and as shown in FIG. 7, the display panel 60 is arranged at a light-emitting surface of the backlight module.

In the display device according to the embodiments of the present disclosure, no polarizer is required at a side of the display device closer to the backlight module as the backlight module can emit polarized light, thereby reducing the thickness of the display device.

In addition, unless otherwise defined, technical terms or scientific terms used in the present disclosure should be interpreted according to common meanings thereof as commonly understood by those of ordinary skills in the art. Such terms as “first”, “second” and the like used in the present disclosure do not represent any order, quantity or importance, but are merely used to distinguish different components. Such terms as “connected”, or “interconnected” and the like are not limited to physical or mechanical connections, but may include electrical connections, whether direct connection or indirect connection. Such terms as “on”, “under”, “left”, “right” and the like are only used to represent a relative position relationship, and when an absolute position of a described object is changed, the relative position relationship thereof may also be changed accordingly.

The above embodiments are merely optional embodiments of the present disclosure. It should be noted that numerous improvements and modifications may be made by those skilled in the art without departing from the principle of the present disclosure, and these improvements and modifications shall also fall within the scope of the present disclosure.

1. An optical film, comprising:
a polarizing film, configured to convert light with a first wavelength into polarized light and transmit the polarized light; and
a diffusion film arranged on the polarizing film, wherein the diffusion film comprises a scattering particle enabling Rayleigh scattering to occur to light with the first wavelength when encountering the scattering particle.

2. The optical film according to claim 1, wherein a diameter d of the scattering particle and the first wavelength λ meet a following equation:
d=αλ/π,
wherein a value of α<0.3 results in occurrence of Rayleigh scattering when the light with the first wavelength λ encounters the scattering particle, and α is a dimensionless particle size parameter.

3. The optical film according to claim 1, wherein the polarizing film is a dual brightness enhancing film, and is configured to divide the light with the first wavelength into P-polarized light and S-polarized light with mutually perpendicular polarization directions, transmit the P-polarized light and reflect the S-polarized light.

4. The optical film according to claim 2, wherein the diameter of the scattering particle is smaller than 70 nm.

5. A backlight module, comprising a light source and an optical film, wherein the optical film comprises:
a polarizing film, configured to convert light with a first wavelength into polarized light and transmit the polarized light; and
a diffusion film arranged on the polarizing film, wherein the diffusion film comprises a scattering particle enabling Rayleigh scattering to occur to light with the first wavelength when encountering the scattering particle,
wherein the light source is arranged at a side of the polarizing film far away from the diffusion film.

6. The backlight module according to claim 5, wherein a diameter d of the scattering particle and the first wavelength λ meet a following equation:
d=αλ/π,
wherein a value of α<0.3 results in occurrence of Rayleigh scattering when the light with the first wavelength λ encounters the scattering particle, and α is a dimensionless particle size parameter.

7. The backlight module according to claim 5, wherein the polarizing film is a dual brightness enhancing film, and is configured to divide the light with the first wavelength into P-polarized light and S-polarized light with mutually perpendicular polarization directions, transmit the P-polarized light and reflect the S-polarized light.

8. The backlight module according to claim 5, further comprising:
a quantum dot film, arranged at a side of the diffusion film far away from the polarizing film, wherein quantum dots in the quantum dot film emit a second light ray under excitation of a first light ray emitted by the light source, and a wavelength of the second light ray is smaller than a wavelength of the first light ray.

9. The backlight module according to claim 5, further comprising:
a reflective film, arranged at a side of the light source far away from the polarizing film.

10. The backlight module according to claim 9, wherein the light source comprises a blue LED chip.

11. The backlight module according to claim 10, wherein the light source comprises a plurality of blue LED chips that are equally spaced.

12. The backlight module according to claim 8, wherein in response to the light source emitting blue light, the quantum dots in the quantum dot film emit green-waveband light and red-waveband light under excitation of the blue light.

13. The backlight module according to claim 9, wherein the reflective film is an enhanced specular reflector (ESR) film.

14. A display device, comprising a display panel and the backlight module according to claim 5, wherein the display panel is arranged at a light-emitting surface of the backlight module.

15. The display device according to claim 14, wherein a diameter d of the scattering particle and the first wavelength λ meet a following equation:
d=αλ/π,
wherein a value of α<0.3 results in occurrence of Rayleigh scattering when the light with the first wavelength λ encounters the scattering particle, and α is a dimensionless particle size parameter.

16. The display device according to claim 14, wherein the polarizing film is a dual brightness enhancing film, and is configured to divide the light with the first wavelength into P-polarized light and S-polarized light with mutually perpendicular polarization directions, transmit the P-polarized light and reflect the S-polarized light.

17. The display device according to claim 14, wherein the backlight module further comprises:
a quantum dot film, arranged at a side of the diffusion film far away from the polarizing film, wherein quantum dots in the quantum dot film emit a second light ray under excitation of a first light ray emitted by the light source, and a wavelength of the second light ray is smaller than a wavelength of the first light ray.

18. The display device according to claim 14, wherein the backlight module further comprises:
a reflective film, arranged at a side of the light source far away from the polarizing film, and the reflective film is an enhanced specular reflector (ESR) film.

19. The display device according to claim 18, wherein the light source comprises a plurality of blue LED chips that are equally spaced.

20. The display device according to claim 17, wherein in response to the light source emitting blue light, the quantum dots in the quantum dot film emit green-waveband light and red-waveband light under excitation of the blue light.
